(19) United States
(12) Patent Application Publication
(10) Pub. No.: US 2018/0128395 A1
(43) Pub. Date: May 10, 2018

(54) BALL VALVE WITH COLOR-CODED INDICATOR OF NORMAL OPERATING POSITION

(71) Applicant: Globe Fire Sprinkler Corporation, Standish, MI (US)

(72) Inventor: Stephen J. MEYER, Chester Springs, PA (US)

(21) Appl. No.: 15/808,289

(22) Filed: Nov. 9, 2017

Related U.S. Application Data
(60) Provisional application No. 62/420,277, filed on Nov. 10, 2016.

(51) Int. Cl. F16K 37/00; F16K 1/14

(52) U.S. Cl. CPC F16K 37/0058; F16K 1/14

(57) ABSTRACT

A ball valve comprises a body, an inlet, an outlet, a stem, and a handle secured to the stem. The ball valve has a normal operating position and an indicator. The indicator has a color, and the color indicates the normal operating position of the ball valve. A method of configuring a piping system including ball valves for operation includes the following steps: supplying, for each ball valve, an indicator which communicates whether a ball valve is open under normal operating conditions or closed under normal operating conditions; determining, for each ball valve, whether the ball valve is open under normal operating conditions or closed under normal operating conditions; and applying the indicator to the ball valve according to the function of the ball valve in the piping system.

### CROSS-REFERENCE TO RELATED APPLICATIONS

This application claims the benefit of priority under 35 USC § 119(e) of U.S. Provisional Patent Application No. 62/420,277 filed Nov. 10, 2016, the contents of which are incorporated herein by reference.

### BACKGROUND OF THE INVENTION

The present invention relates generally to valves, and more particularly to ball valves, including but not limited to ball valves used for controlling fluid flow in systems for fire protection.

A ball valve is a device for controlling fluid flow. A ball valve typically includes a body, an inlet, an outlet, a fluid path through the body, and a hollow, generally spherical ball sealingly supported in the fluid path. Two apertures pass through the wall of the ball and are preferably located at diametrically opposing locations on the ball. A stem is secured to the ball and passes through the body generally perpendicular to the apertures. A handle, which is preferably made from a shaped metal plate, is secured to the stem and extends radially from the stem. The handle and the stem rotate the ball to alter the alignment of the apertures with the fluid path. When the apertures align with the fluid path, the valve is open, and fluid flows through the valve. When the apertures of the ball are offset 90 degrees from the fluid path, the fluid path is blocked by the ball, the valve is closed, and fluid does not flow though the valve. The stem and the handle are configured to move through a 90-degree range of motion, with the open and closed positions at opposite ends of the range. Conventionally, the valve and the handle are configured so that when the handle is aligned with the fluid path and the body, the valve is open, whereas when the handle is oriented perpendicularly to the fluid path and the body, the valve is closed. Due to this convention, the position of the handle of a ball valve indicates whether the valve is open or closed.

It is common for a piping system to contain a plurality of ball valves, with each valve having a first position (open or closed) under normal operating conditions and a second position under other conditions, such as shutdowns, testing, or maintenance. For example, in a dry sprinkler system, a first ball valve is used to admit air into a branch line and is open under normal operating conditions, while a second ball valve controls flow in a drain line and is closed under normal operating conditions.

It may not be a simple matter for an operator to determine whether, under the configuration of a particular piping system, the position of a particular ball valve is open or closed under normal operating conditions. A ball valve according to the invention provides a visual indication of whether the valve should be open or closed under normal operating conditions. As a result, when the normal operating positions of one or more valves have been changed for purposes of testing, maintenance, or the like, and an operator needs to return the valves to the normal operating position, the operator is able to do so based on a visual indication of the valve, rather than by examining the piping system, a schematic drawing, or written instructions. Similarly, in an a piping system containing a plurality of distinct pipes, or in an area where a plurality of pipes from separate piping systems are found, it may not be a simple matter for an operator to locate the ball valve controlling fluid flow in a particular pipe. A ball valve according to a preferred embodiment of the invention includes a label area indicating the particular fluid flow controlled by the ball valve. A ball valve with an indicator of both the fluid flow controlled by the valve and the normal operating position of the valve makes identification and operation of the valve simpler, quicker, and more reliable.

### BRIEF SUMMARY OF THE INVENTION

Briefly stated, in a preferred embodiment of the present invention, a ball valve comprises a body, an inlet, an outlet, a stem, and a handle secured to the stem. The ball valve has a normal operating position and an indicator. The indicator has a color, and the color indicates the normal operating position of the ball valve.

In another preferred embodiment of the invention, a kit for installing a ball valve in a piping system comprises a ball valve, a first indicator, and a second indicator. The ball valve comprises a body, an inlet, an outlet, a stem, and a handle secured to the stem. The ball valve has a normal operating position. The first indicator is adapted for application to the ball valve and has a first color for indicating that the normal operating position of the ball valve is an open position. The second indicator is adapted for application to the ball valve and has a second color for indicating that the normal operating position of the ball valve is a closed position.

Another preferred embodiment of the invention is a method of configuring a piping system comprising ball valves for operation. The method comprises the following steps: determining, for a ball valve, a normal operating position; supplying an indicator for the ball valve, the indicator having a color, the color indicating the normal operating position of the ball valve; and applying the indicator to the ball valve.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a perspective view of a sleeve for mounting on the handle of a ball valve according to a preferred or an exemplary embodiment of the invention;

FIG. 2 is a top plan view of a ball valve according to the embodiment shown in FIG. 1;

FIG. 3 is a top plan view of a ball valve according to a second embodiment of the invention;

FIG. 4 is a top plan view of a ball valve according to a third embodiment of the invention;

FIG. 5 is a top plan view of an alternative embodiment of a ball valve;

FIG. 6 is a top plan view of a further alternative embodiment of a ball valve; and

FIG. 7 is a top plan view of a further alternative embodiment of a ball valve.

### DETAILED DESCRIPTION OF THE INVENTION

Certain terminology is used in the following description for convenience only and is not limiting. The words “right,” “left,” “lower,” and “upper” designate directions in the drawings to which reference is made. The words “inner” and “outer” refer to directions toward and away from, respectively, the geometric center of the device and designated parts thereof. Unless specifically set forth herein, the terms “a,” “an,” and “the” are not limited to one element but instead should be read as meaning “at least one.” The terminology includes the words noted above, derivatives thereof and words of similar import.

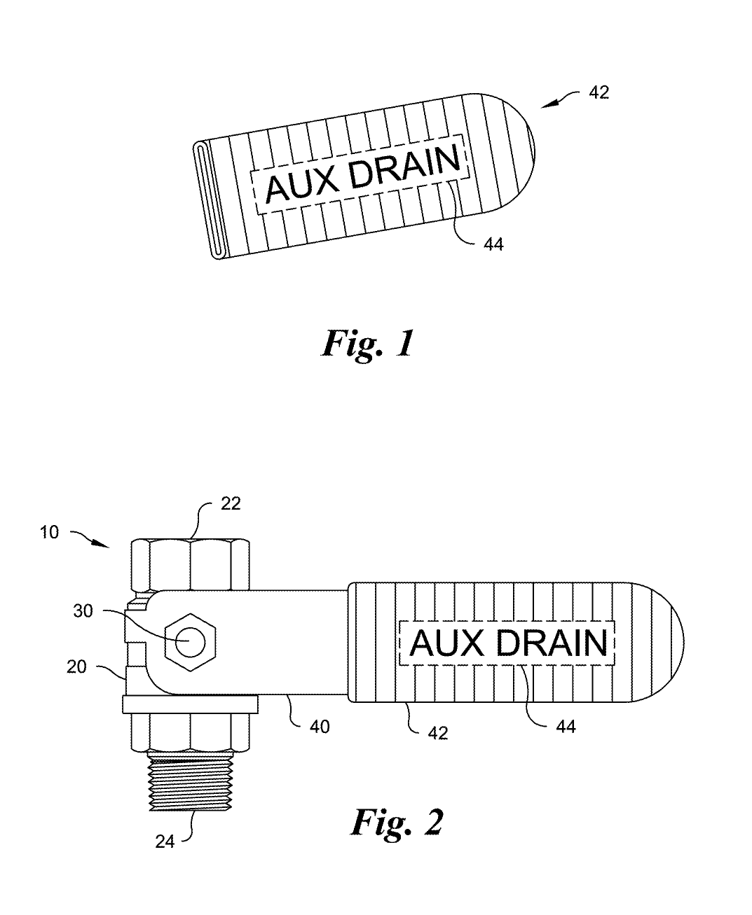

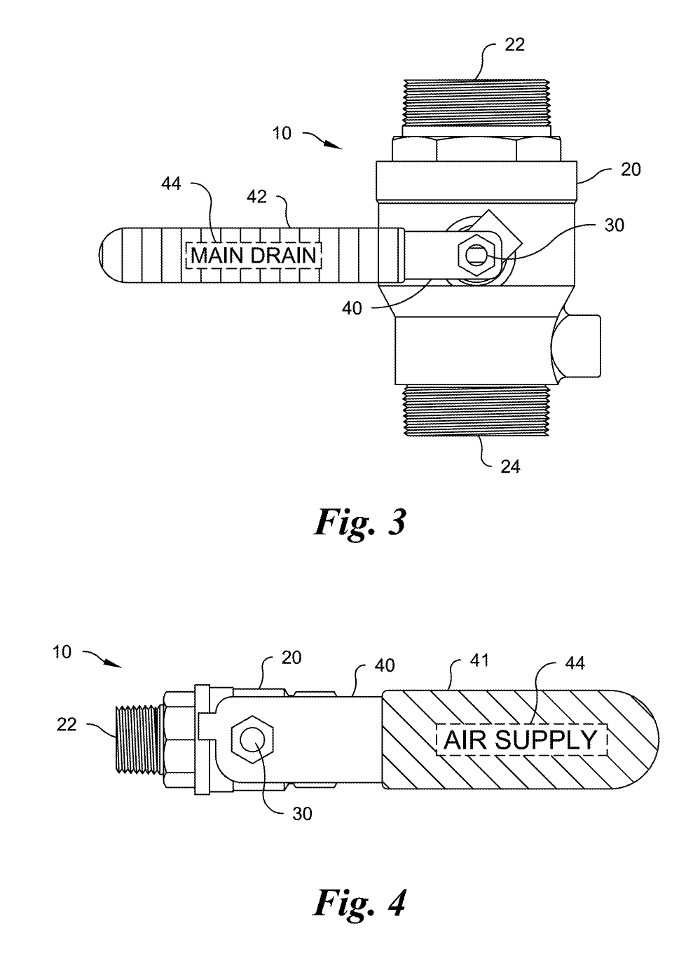

Referring to FIGS. 1-4, preferred embodiments of the present invention are directed to a ball valve 10 having a body 20, an inlet 22, an outlet 24, a stem 30, and a handle 40 secured to the stem 30. The handle 40 has an indicator, which in the embodiments shown in FIGS. 1-4 is a sleeve 41, 42 sized to slide onto and fit snugly on the handle 40. The sleeve 41, 42 is preferably rubber and serves as an indicator of the normal operating position of the ball valve—that is, as indicator of whether the ball valve 10 is open under normal operating conditions or closed under normal operating conditions. In a preferred embodiment, the sleeve 41 (see FIG. 4) is green, while the sleeve 42 (see FIG. 1) is red. Each sleeve 41, 42 preferably indicates the normal operating position of the ball valve 10 by color coding. The sleeve 41, 42 preferably also includes a label area 44, which displays text indicating the fluid flow controlled by the ball valve 10. In FIG. 2, a valve 10, as used in a particular piping system, is closed under normal operating conditions and has a red indicator in the form of a red sleeve 42 with a label area 44 displaying the text AUX DRAIN. The label area 44 is preferably pre-printed with the desired text but may also include an area suitable for application of a pre-printed label with the appropriate text. Thus in FIG. 4, a valve 10 that is open under normal operating conditions has a green indicator in the form of a green sleeve 41 and preferably includes a label area 44 displaying the text AIR SUPPLY.

For an operator performing maintenance or other work requiring a change in the position of one or more ball valves, restoring the valves to normal operating positions is a simple matter of closing the valves with red indicators and opening the valves with green indicators. The operator need not examine the physical layout of the piping system to make a determination of what flows are controlled by a particular ball valve, and the operator need not make a further determination of whether a particular valve should be open or closed under normal operating conditions. Similarly, the operator need not examine the physical layout of the piping system, or the pipes in a particular area of a building, to select the ball valve controlling a particular fluid flow. Instead, the operator may simply examine the text on the label area of ball valves to select the correct valve. The use of ball valves according to the invention is particularly advantageous where numerous ball valves are found in close proximity to one another, and even more advantageous in an emergency in which an operator must quickly select and operate the correct ball valve.

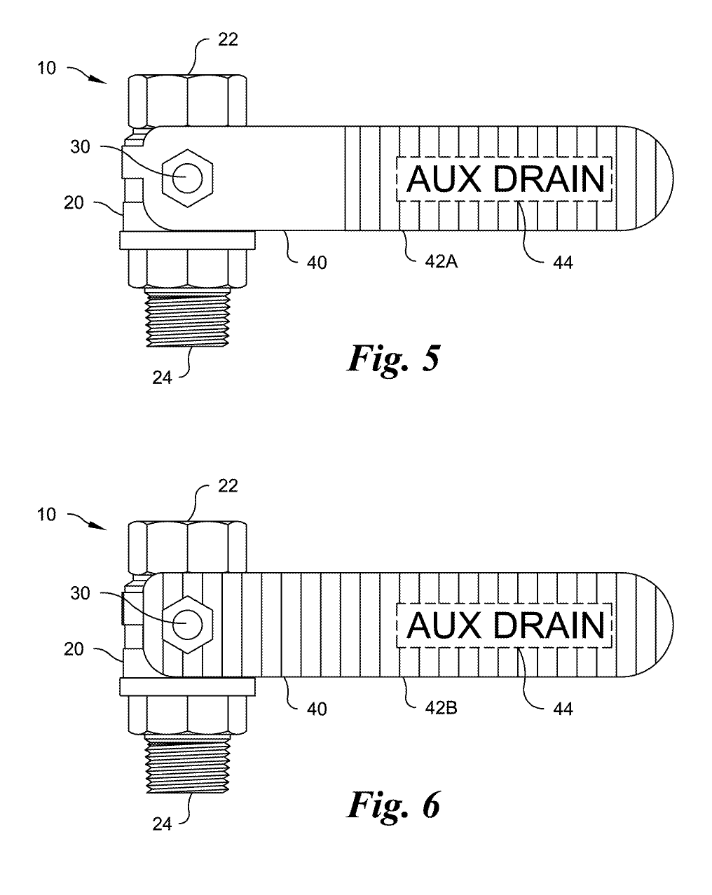

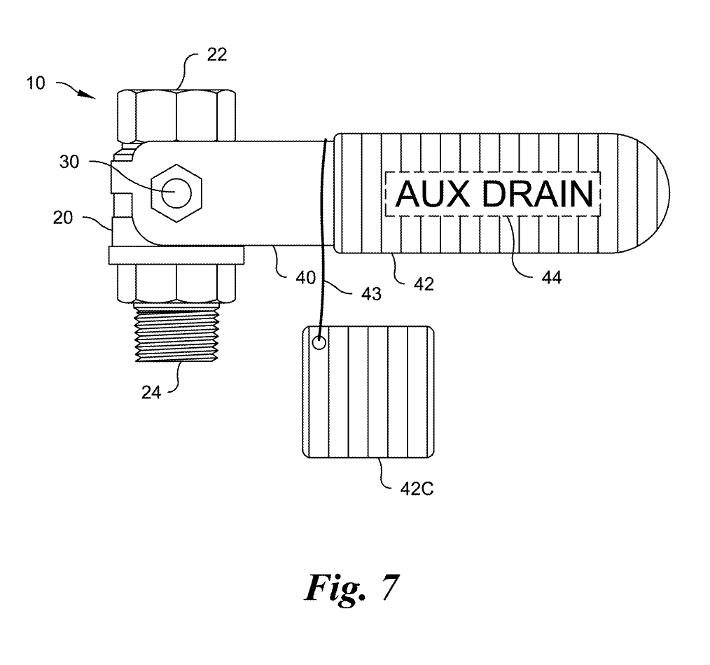

The indicators according to the invention may preferably be made in a variety of forms. In the exemplary embodiments of FIGS. 1-4, the indicator is a colored sleeve 41, 42; but sleeves of other materials, as well as other means of applying color to a handle, also may be used. For example, as shown in FIG. 5, a handle 40 for a ball valve 10 may have an indicator formed by a coating 42A formed from colored rubber or paint. Alternatively, as shown in FIG. 6, a handle 40 for a ball valve 10 may have an indicator in the form of a handle 42B molded from a colored material to form an indicator of the proper condition of the valve under normal operating conditions from colored rubber or paint. Further alternatively, a ball valve 10 or a portion thereof such as a handle 40 may have applied thereto an indicator in the form of a tag 42C attached by a cord 43, by an adhesive, or in another suitable manner; the tag 42C may be used with or without a colored sleeve 41, 42, and with or without a label area 44. Ball valves may be supplied pre-configured with the correct indicator.

In another preferred embodiment of the invention, a kit for installing a ball valve 10 in a piping system comprises a ball valve 10, a first indicator, and a second indicator. The indicators may be sleeves 41, 42 or may be coatings 42A, handles 42B molded from colored material, or tags 42C, and any indicator may include a label area 44, with or without pre-printed text, for indicating the fluid flow controlled by the ball valve 10. The ball valve 10 comprises a body 20, an inlet 22, an outlet 24, a stem 30, and a handle 40 secured to the stem 30. The ball valve 10 has a normal operating position. The first indicator is adapted for application to the ball valve and has a first color for indicating that the normal operating position of the ball valve is an open position. The second indicator is adapted for application to the ball valve and has a second color for indicating that the normal operating position of the ball valve is a closed position.

In a preferred embodiment, a ball valve or a kit containing a plurality of ball valves 10 may be supplied with one or more sleeves 41, 42 according to the invention to be placed on each ball valve 10 after the use of the ball valve 10 is determined. Finally, sleeves 41, 42 may be supplied separately from ball valves 10 and may be sold for use in retrofitting existing ball valves 10 according to the invention.

The invention includes a method of configuring a piping system comprising ball valves for operation comprising the following steps: supplying, for each ball valve 10, an indicator (for example, 41, 42, 42A, 42B, or 42C) which communicates whether a ball valve 10 is open under normal operating conditions or closed under normal operating conditions (this may be accomplished by providing a plurality of indicators to be applied as needed to a plurality of ball valves 10); determining, for each ball valve 10, whether the ball valve 10 is open under normal operating conditions or closed under normal operating conditions; and applying the indicator to the ball valve 10 according to the function of the ball valve 10 in the piping system. In some embodiments of a method according to the invention, the supplied indicators are rubber sleeves 41, 42 which indicate the normal operating position of the ball valve 10 by color coding. In further embodiments, each indicator preferably includes a label area 44, which displays text indicating the fluid flow controlled by the ball valve 10. In a still further embodiment of a method according to the invention, each has a label area 44 and is supplied pre-printed with the desired text. Preferably for each ball valve 10 of the plurality of ball valves 10 having the normal operating position being open, the color of the indicator is a first color, and for each ball valve 10 of the plurality of ball valves 10 having the normal operating position being closed, the color of the indicator is a second color. Still more preferably, the first color is green, and the second color is red.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/We claim:

1. A ball valve comprising:
a body;
an inlet;
an outlet;
a stem; and
a handle secured to the stem,
the ball valve having a normal operating position and an indicator, the indicator having a color, the color indicating the normal operating position of the ball valve.

2. The ball valve of claim 1, wherein the indicator comprises a sleeve fitted to the handle.

3. The ball valve of claim 1, wherein the handle has an exterior surface and the indicator comprises a coating on the exterior surface.

4. The ball valve of claim 1, wherein the color of the indicator is green and indicates the normal operating position of the ball valve being open.

5. The ball valve of claim 1, wherein the color of the indicator is red and indicates the normal operating position of the ball valve being closed.

6. The ball valve of claim 1, wherein the handle is molded from a material having the color of the indicator indicating the normal operating position of the ball valve.

7. The ball valve of claim 1, wherein the ball valve is installed in a piping system to control a fluid flow and the indicator further comprises a label area for indicating the fluid flow controlled by the ball valve.

8. The ball valve of claim 2, wherein the sleeve comprises a rubber material.

9. The ball valve of claim 1, wherein the indicator comprises a tag fitted to the ball valve and comprising a colored portion having the color of the indicator.

10. A kit for installing a ball valve in a piping system, the kit comprising:
a ball valve comprising a body, an inlet, an outlet, a stem, and a handle secured to the stem, the ball valve having a normal operating position;
a first indicator adapted for application to the ball valve, the first indicator having a first color for indicating that the normal operating position of the ball valve is an open position; and
a second indicator adapted for application to the ball valve, the second indicator having a second color for indicating that the normal operating position of the ball valve is a closed position.

11. The kit of claim 10, wherein at least one of the first indicator and the second indicator is a sleeve fitted to the handle.

12. The kit of claim 10, wherein the ball valve is installed in a piping system to control a fluid flow and at least one of the first indicator and the second indicator comprises a label area for indicating the fluid flow controlled by the ball valve.

13. The kit of claim 12, wherein at least one of the first indicator and the second indicator comprises pre-printed text in the label area, the text indicating the fluid flow controlled by the ball valve upon installation in a piping system.

14. A method of configuring a piping system comprising ball valves for operation, the method comprising the following steps:
determining, for a ball valve, a normal operating position;
supplying an indicator for the ball valve, the indicator having a color, the color indicating the normal operating position of the ball valve; and
applying the indicator to the ball valve.

15. The method of claim 14, wherein the ball valve controls a fluid flow and the indicator further comprises a label area for indicating the fluid flow controlled by the ball valve.

16. The method of claim 15, wherein the label area comprises preprinted text in the label area, the text indicating the fluid flow controlled by the ball valve upon installation in a piping system.

17. The method of claim 14, further comprising repeating the method steps of claim 14 for each of a plurality of ball valves in a piping system, wherein for each ball valve of the plurality of ball valves having the normal operating position being open, the color of the indicator is a first color, and for each ball valve of the plurality of ball valves having the normal operating position being closed, the color of the indicator is a second color.
